(19) United States
(12) Patent Application Publication
(10) Pub. No.: US 2004/0086114 A1
(43) Pub. Date: May 6, 2004

(54) System and method for implementing DES permutation functions

(75) Inventor: Leonard D. Rarick, San Diego, CA (US)

Correspondence Address: Brian M. Berliner, O'MELVENY & MYERS LLP, 400 So. Hope Street, Los Angeles, CA, 90071-2899, US

(73) Assignee: SUN MICROSYSTEMS, INC.

(21) Appl. No.: 10/289,970

(22) Filed: Nov. 6, 2002

(51) Int. Cl. H04K 1/00

(52) U.S. Cl. 380/29

(57) ABSTRACT

A system and method is provided for using a general purpose processor to implement permutation and/or round opcodes for encrypting and/or decrypting data in accordance with the data encryption standard (DES) algorithm. In one embodiment of the present invention, an encryption unit is adapted to implement a permutation (or rotation) function on a first operand obtained from a general purpose register, where the permutation function is derived from a permutation opcode and a second operand provided to the encryption unit. In this embodiment, the permutation opcode is used to instruct the encryption unit to perform a permutation function, and the second operand is used to delineate which permutation function is to be performed. In another embodiment of the present invention, the encryption unit is adapted to implement a round function on two operands obtained from general purpose registers. In this embodiment a round opcode is used to instruct the encryption unit to perform the round function. In another embodiment, the encryption unit is adapted to perform the round function by implementing four permutation and two exclusive-or functions.

### BACKGROUND OF THE INVENTION

1. Field of the Invention

The present invention relates to systems for encrypting and/or decrypting data, or more particularly, to a system and method for using a general purpose processor to implement permutation and/or round opcodes for encrypting and/or decrypting data in accordance with the data encryption standard (DES) algorithm.

2. Description of Related Art

Cryptography (i.e., the encoding and decoding of data) allows data to be stored and/or transmitted in a secure manner. This is typically done by (i) using an algorithm to encode plaintext (i.e., readable data) into ciphertext (i.e., unreadable data), (ii) transmitting the ciphertext to a recipient, and (iii) using the same algorithm, inversed, to decode the ciphertext back into readable plaintext. This method of securing data prevents third parties that are not privy to the algorithm used from intercepting and understanding the transmitted data.

The problem with such a system, however, is that as more people (i.e., senders and recipients) become involved, it becomes harder to ensure that each recipient is capable of decoding the ciphertext. For example, a land surveyor may electronically communicate with a number of government agencies (e.g., the department of fish and wildlife, the department of ecology, etc.). But, if each government entity uses a different algorithm to secure their electronic transmissions, the land surveyor needs hardware and/or software capable of processing each algorithm being used. This can become extremely expensive and cumbersome. Thus, a need existed for a standardized method of securing electronic data.

This resulted in the federal government and the American National Standards Institute (ANSI) adopting the Data Encryption Standard (DES) as a standard by which electronically transmitted data would be secured. DES provides a standardized algorithm for encoding and decoding data. The data is maintained secure through the use of a key (i.e., key data). In other words, DES involves the steps of (i) generating/obtaining key data, (ii) using the key data and the DES algorithm to encode plaintext into ciphertext, (ii) transmitting the ciphertext to a recipient, and (iii) using the same key data and the DES algorithm, inversed, to decode the ciphertext back into readable plaintext. Such a system allows recipients to receive and decode ciphertext from various senders by merely knowing the key data that was used to encode the plaintext.

DES is traditionally implemented using a general purpose processor and either (1) dedicated hardware (i.e., a dedicated DES processor) or (2) software routines. The problem with these prior art processing systems is that they either increase the cost of the processing system (e.g., by requiring a dedicated DES processor) or increase the processing time needed to perform the DES algorithm (e.g., by using the general purpose processor's standard instruction set to perform the DES algorithm). Thus, it would be advantageous to have a system and method for encrypting and/or decrypting data in accordance with the DES algorithm that overcame these deficiencies.

### SUMMARY OF THE INVENTION

The present invention provides a system and method for using a general purpose processor to implement permutation and/or round opcodes for encrypting and/or decrypting data in accordance with the data encryption standard (DES) algorithm. Embodiments of the present invention operate in accordance with a general purpose processor that includes an encryption unit, general purpose registers, and a control unit.

The DES algorithm can be divided into thirty-four separate and discrete steps. Non-standard functions that are necessary to perform these thirty-four steps (for both encryption and decryption) include an initial-permutation function, a key-permutation (encryption) function, a key-permutation (decryption) function, a rotation-by-one-to-the-left function, a rotation-by-two-to-the-left function, a rotation-by-one-to-the-right function, a rotation-by-two-to-the-right function, a final-permutation function, and a round function, where the permutation and rotation functions operate on a single set of data and the round function operates on two sets of data. Thus, the DES algorithm can be implemented through the performance of round functions that operate on two values, and eight permutation (or rotation) functions that operate on a single value.

In one embodiment of the present invention, the encryption unit is adapted to implement the eight permutation (or rotation) functions. Specifically, the control unit fetches a permutation instruction that includes an opcode (i.e., a permutation opcode), a destination identifier (e.g., rd), an operand identifier (e.g., rs1), and a permutation identifier (e.g., rs2). The value of the permutation identifier delineates which permutation (or rotation) is to be performed. The control unit decodes the opcode to determine that a permutation function is to be performed. The control unit then provides a permutation request and the permutation identifier to the encryption unit, and provides the operand identifier to the general purpose registers. After the content of the particular register identified by the operand identifier (e.g., r[rs1]) is provided to the encryption unit, the encryption unit performs the requested permutation (or rotation) function as delineated by the permutation identifier. The requested permutation is performed on the content of the identified register (e.g., r[rs1]) to produce a result. The control unit then provides the destination identifier to the general purpose registers. This allows the result to be loaded into a general purpose register identified by the destination identifier (e.g., register rd).

In another embodiment of the present invention, the encryption unit is adapted to implement the round function. Specifically, the control unit fetches a round instruction that includes an opcode (i.e., a round opcode), a destination identifier (e.g., rd), and two operand identifiers (e.g., rs1, rs2). The content of the register identified by the first operand identifier (e.g., rs1) is the text operand for the round function and the content of the register identified by the second operand identifier (e.g., rs2) is the key operand for the round function. The control unit decodes the opcode to determine that a round function is to be performed. The control unit then provides a round request to the encryption unit and the two operand identifiers to the general purpose registers. After the contents of the particular registers identified by the two operand identifiers (e.g., r[rs1], r[rs2]) are provided to the encryption unit, the encryption unit performs the round function, which includes performing three sub-functions (i.e., a first exclusive-or (XOR) function, a look-up table function, and a second XOR function), on the contents of the identified registers (e.g., r[rs1], r[rs2]) to produce a result. The control unit then provides the destination identifier to the general purpose registers. This allows the result to be loaded into the general purpose register identified by the destination identifier (e.g., register rd).

In another embodiment of the present invention, the round function is implemented using four permutations and two XOR functions. Specifically, an expansion permutation function is implemented to produce a forty-eight bit R value from a text operand, and a select-key permutation function is implemented to produce a forty-eight bit Y value from a key operand. A first XOR function is then performed on the forty-eight bit R value and Y value, resulting in a forty-eight bit E value. A value-substitution permutation and a bit permutation are then implemented to produce a thirty-two bit Z value from the E value. A second XOR function is then performed on the thirty-two bit Z value and text operand, resulting in a thirty-two bit P value. The thirty-two bit P value, along with the text operand, is then used to determine the result.

A more complete understanding of the system and method for using a general purpose processor to implement at least a portion of the DES algorithm will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 illustrates a prior art system that performs the DES algorithm.

FIG. 2 illustrates a processing system operating in accordance with one embodiment of the present invention.

FIG. 3 illustrates components that may be included in the general purpose processor depicted in FIG. 2.

FIG. 4-1 illustrates an exemplary instruction set of the general purpose processor depicted in FIGS. 2 and 3.

FIG. 4-2 identifies the operands to, and the results of, the functions corresponding to the opcodes identified in FIG. 4-1.

FIG. 5 depicts thirty-four computational steps that can be performed to implement the DES algorithm.

FIG. 6 provides the initial permutation (i.e., step one) of the DES algorithm.

FIG. 7 provides the key permutation (i.e., step two) of the DES algorithm for decrypting data.

FIG. 8 provides the key permutation (i.e., step two) of the DES algorithm for encrypting data.

FIG. 9 provides a first XOR portion of the round computation (e.g., step three) of the DES algorithm.

FIG. 10 provides a second XOR portion of the round computation (e.g., step three) of the DES algorithm.

FIGS. 11-1 and 11-2 provides a look-up table (or value substitution permutation) portion of the round computation (e.g., step three) of the DES algorithm.

FIG. 12 provides the final permutation (i.e., step thirty-four) of the DES algorithm.

FIG. 13 provides an expansion permutation portion of the round computation (e.g., step three) of the DES algorithm.

FIG. 14 provides a select-key permutation portion of the round computation (e.g., step three) of the DES algorithm.

FIG. 15 provides a bit permutation portion of the round computation (e.g., step three) of the DES algorithm.

### DETAILED DESCRIPTION OF THE PREFERRED EMBODIMENT

The present invention provides a system and method for using a general purpose processor to implement permutation and/or round opcodes for encrypting and/or decrypting data in accordance with the data encryption standard (DES) algorithm. In the detailed description that follows, like element numerals are used to describe like elements illustrated in one or more figures.

FIG. 1 illustrates a prior art processing system 10 for encrypting and/or decrypting data in accordance with the DES algorithm. This prior art processing system 10 includes a local communication device 100, a general purpose processor 110, and either (1) dedicated hardware (i.e., a dedicated DES processor 140) or (2) software routines (which may be provided by a storage device 130) adapted to communicate with the general purpose processor 110 via a plurality of information lines (i.e., 112, 114, 132, 142). It should be appreciated that the information lines discussed herein (i.e., 202, 212, etc.) include, but are not limited to, internal/external buses, local/wide area networks (e.g., Ethernet, Internet, etc.), and all other forms of digital, analog, optical, wireless, or physically connected communication technologies generally known to those skilled in the art. It should further be appreciated that the local communication devices discussed herein (i.e., 100 and 200) include, but are not limited to, personal computers, personal digital assistances (PDAs), telephones, and other types of wireless or physically connected devices, including digital, optical and analog devices, that transmit and/or receive data generally known to those skilled in the art.

In the prior art processing unit 10, readable data (i.e., plaintext) is encrypted by providing plaintext, key data and an encryption request to the general purpose processor 110. If the processing system 10 is using dedicated hardware to perform the DES algorithm, the plaintext, key data, and encryption request are forwarded to the DES processor 140 via information line 114. The DES processor 140 then uses the key data to encrypt the plaintext in accordance with the DES algorithm. Once the encryption is complete, the DES processor 140 provides the resulting data (i.e., ciphertext) to the general purpose processor 110 via information line 142, where it is either forwarded to the local communication device 100 via information line 102, or forwarded externally (e.g., to a remotely located device) via information line 116. A similar process is used for decrypting ciphertext (i.e., converting ciphertext to plaintext).

Alternatively, if the processing system 10 is using software routines to perform the DES algorithm, the encryption request is forwarded to the storage device 130 via information line 112. In response, the storage device 130 provides an encryption software routine to the general purpose processor 110 via information line 132. The encryption software routine is adapted to use the general purpose processor's standard instruction set (e.g., add, shift, subtract, etc.) and the key data to encrypt the plaintext in accordance with the DES algorithm Once the general purpose processor has performed the encryption software routine, the encoded data (i.e., ciphertext) is either forwarded as previously discussed or stored in the storage device 130 via information line 112. A similar process is used for decrypting ciphertext (i.e., converting ciphertext to plaintext).

A drawback of these two types of prior art processing systems is that they typically require added expense, size, and/or processing time. For example, the prior art hardware processing system adds expense and size by requiring a dedicated DES processor 140. Furthermore, the prior art software processing system takes longer to process data because the software routines are limited to the standard instruction set available to the general purpose processor (e.g., add, shift, subtract, etc.), and it takes a large number of standard instructions to implement the DES algorithm.

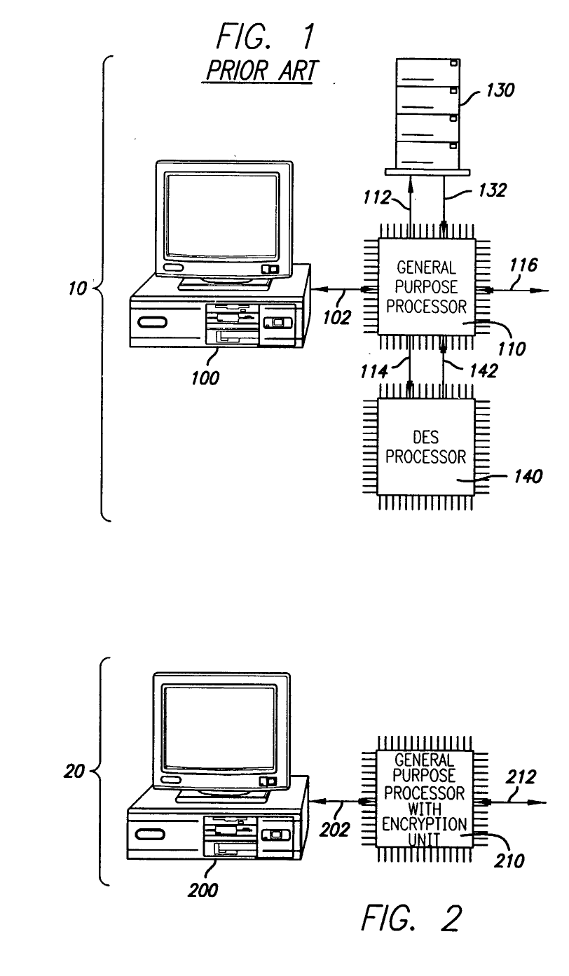

FIG. 2 illustrates an encryption and/or decryption processing system 20 operating in accordance with one embodiment of the present invention. Specifically, a local communication device 200 is operatively connected to a general purpose processor 210 adapted to implement at least one DES opcode (i.e., a round opcode and/or a permutation opcode) for carrying out at least a portion of the DES algorithm. The general purpose processor 210 may also be operatively connected to at least one remotely located device via information line 212. For example, the general purpose processor 210 may be connected via the Internet to a remotely located communication device (not shown). It should be appreciated that the general purpose processors depicted and described herein (e.g., 210) are not limited to any particular type of processor, and include all general purpose processors and/or microprocessors general known to those skilled in the art. It should further be appreciated that the location of the general purpose processor with respect to the local communication device is not material to the present invention. Thus, general purpose processors that are located within, or external to, the local communication device are considered within the spirit and scope of the present invention.

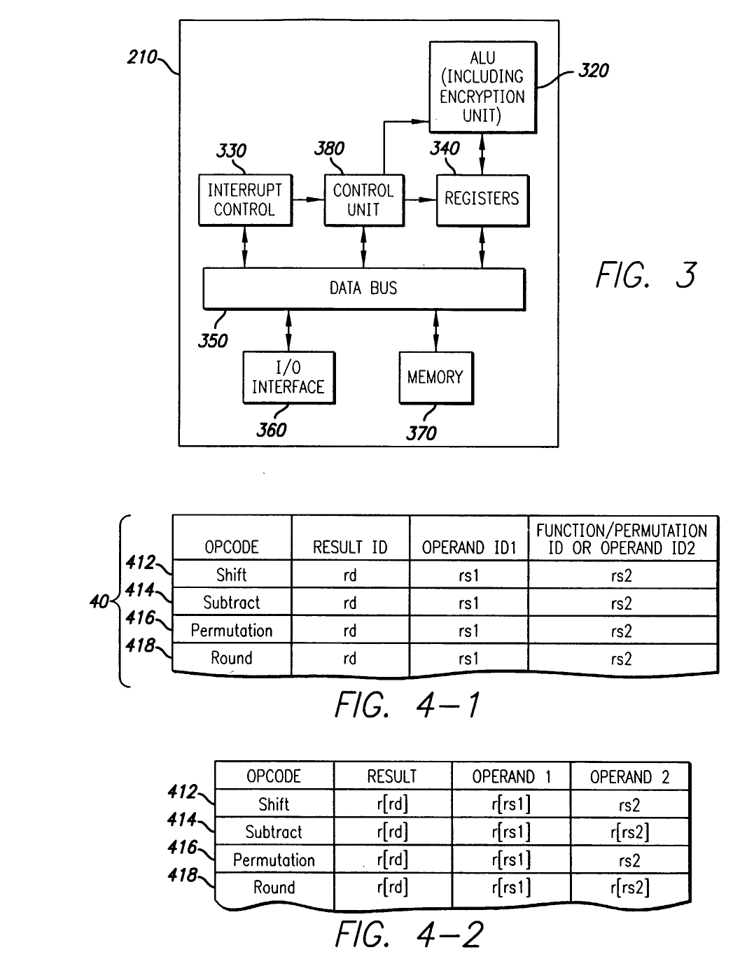

As shown in FIG. 3, the general purpose processor 210 includes an ALU/encryption unit 320 adapted to implement at least one DES opcode (i.e., a permutation opcode and/or a round opcode), a control unit 380, general purpose registers 340, at least one memory device 370, and may further include at least an interrupt control 330, a data bus 350, and an I/O interface 360. While FIG. 3 depicts the encryption unit 320 as being part of the arithmetic logic unit (ALU), it should be appreciated that other encryption units, for example, encryption units that are separate from the ALU, are considered within the spirit and scope of the present invention. It should further be appreciated that the individual components depicted in FIG. 3 are included merely to illustrate the environment in which the present invention may operate, and are not to be construed as limitations on the present invention.

To better understand the present invention, the standard operation of the general purpose processor 210 will first be described. Typically, a program (or software routine) including at least one instruction is received by the I/O interface 360 and stored in memory 370. The control unit 380 then fetches the first instruction in the program, where each instruction typically includes an opcode, a destination identifier, and either (i) two operand identifiers or (ii) a function identifier and an operand identifier. In the first instance, after the control unit 380 has decoded the opcode, the control unit 380 provides an opcode request (identifying the function to be performed) to the ALU/encryption unit 320 and the two operand identifiers to the general purpose registers 340. In the second instance, the control unit 380 provides an opcode request and the function identifier (which further delineates which function is to be performed) to the ALU/encryption unit 320. The control unit 380 then provides the operand identifier to the general purpose registers 340. In both instances, the general purpose registers provide the content(s) of the particular general purpose register(s) identified by the operand identifier(s) to the ALU/encryption unit 380. The ALU/encryption unit 380 then performs the requested function (in the second instance the requested function is further delineated by the function identifier) on the content(s) provided. The result is then provided to the general purpose registers 340, where it is loaded into the particular general purpose register identified by the destination identifier. This allows the ALU/encryption unit 320 to perform a function (e.g., subtract) on two operands (e.g., on two values), or a function (e.g., shift) that is further defined by a function identifier (e.g., the number of positions to be shifted) on another operand (e.g., a value).

For example, FIG. 4-1 illustrates an instruction set 40 that includes a subtract instruction (i.e., subtract opcode 414, result identifier rd, and operand identifiers rs1, rs2). After this instruction is fetched, the control unit 380 decodes the subtract opcode, provides a subtract request to the ALU/encryption unit 320 (i.e., instructing the ALU/encryption unit 320 to perform a subtract function), and distributes the remaining instruction components according to FIG. 4-2. In other words, the control unit 380 provides the operand identifiers rs1, rs2 to the general purpose registers 340. The general purpose registers 340 then provide the contents of registers rs1 (i.e., r[rs1], or the first operand) and rs2 (i.e., r[rs2], or the second operand) to the ALU/encryption unit 320. The ALU/encryption unit 320 then performs a subtract function on the two operands to produce a result. The result is provided to the general purpose registers 340 along with the destination identifier (i.e., rd). This allows the result to be loaded into register rd of the general purpose registers 340. In other words, the result become the contents of register rd (i.e., r[rd]).

Alternatively, after the shift instruction (i.e., shift opcode 412, result identifier rd, operand identifier rs1, and function identifier rs2) is fetched, the control unit 380 decodes the shift opcode, provides a shift request to the ALU/encryption unit 320, (i.e., instructing the ALU/encryption unit 320 to perform a shift function), and distributes the remaining instruction components according to FIG. 4-2. In other words, the control unit 380 provides the function identifier rs2 (i.e., the second operand) to the ALU/encryption unit 320 (i.e., further delineating the type of shift function to be performed) and provides the operand identifier rs1 to the general purpose registers 340. The general purpose registers 340 then provide the content of register rs1 (i.e., r[rs1]), or the first operand) to the ALU/encryption unit 320. The ALU/encryption unit 320 then performs a shift function on the first operand by the amount provided by the second operand (i.e., shift r[rs1] by rs2) to produce a result. The result is provided to the general purpose registers 340 along with the destination identifier (i.e., rd). This allows the result to be loaded into register rd of the general purpose registers 340. It should be appreciated that while a three-address processor has been described, additional processors (e.g., two-address, four-address, etc.) are within the spirit and scope of the present invention.

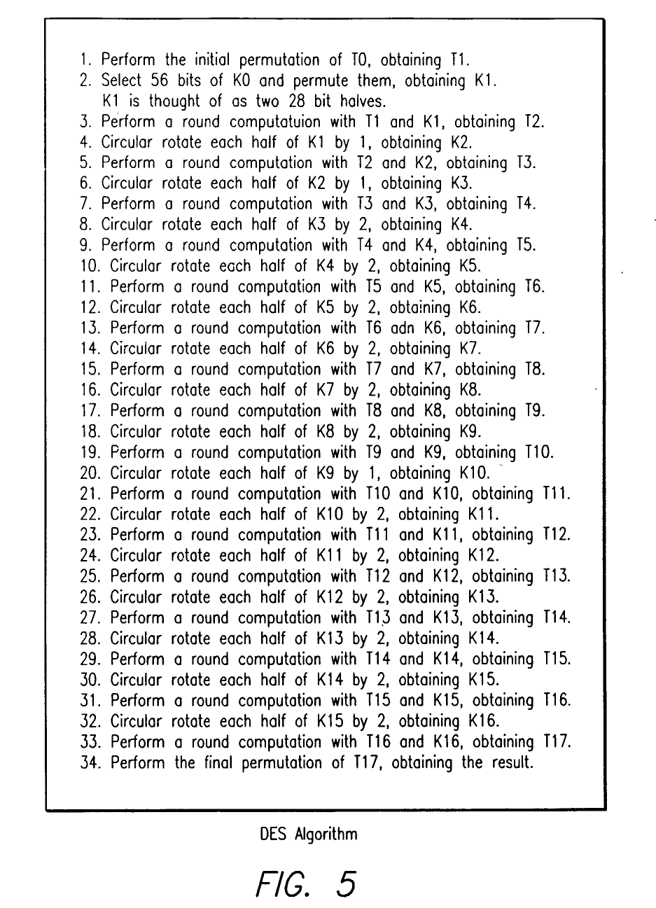

FIG. 5 illustrates how the DES algorithm can be divided into thirty-four separate and discrete steps. Specifically, the DES algorithm can be divided to include an initial permutation, a key permutation, round computations, rotation by one and two computations (which are permutations), and a final permutation. Thus, the DES algorithm can be broken down into two functions—permutations and round computations. While the round computations are the same regardless of whether the data is being encoded or decoded, the same is not necessarily true for the permutations. For example, a first key permutation is used when data is being encrypted and a second key permutation is used when data is being decrypted. Furthermore, the rotation by one or two computations involve rotations to the left when data is being encrypted, and rotations to the right when data is being decrypted. Therefore, the permutations can further be broken down into an initial permutation, a key permutation (encryption), a key permutation (decryption), a rotation by one to the left, a rotation by two to the left, a rotation by one to the right, a rotation by two to the right, and a final permutation. Thus, the DES algorithm can be implemented through the performance of one round function that operates on two values (e.g., in step three, the values are T1 and K1), and eight permutation (or rotation) functions that operate on a single value (e.g., in step 1, the value is T0).

Referring back to FIG. 3, it should be apparent that the general purpose processor 210, or more particularly the ALU/encryption unit 320, can be adapted to implement either one of these functions in the same manner as the ALU/encryption unit 320 currently processes subtract and shift functions. Specifically, as shown in FIGS. 4-1 and 4-2, the round function, like the subtract function, includes an opcode (i.e., a round opcode), a destination identifier, and two operand identifiers. Similarly, the permutation (or rotation) function, like the shift function, includes an opcode (i.e., a permutation opcode), a destination identifier, an operand identifier, and a permutation identifier (i.e., a value to indicate which permutation is to be performed).

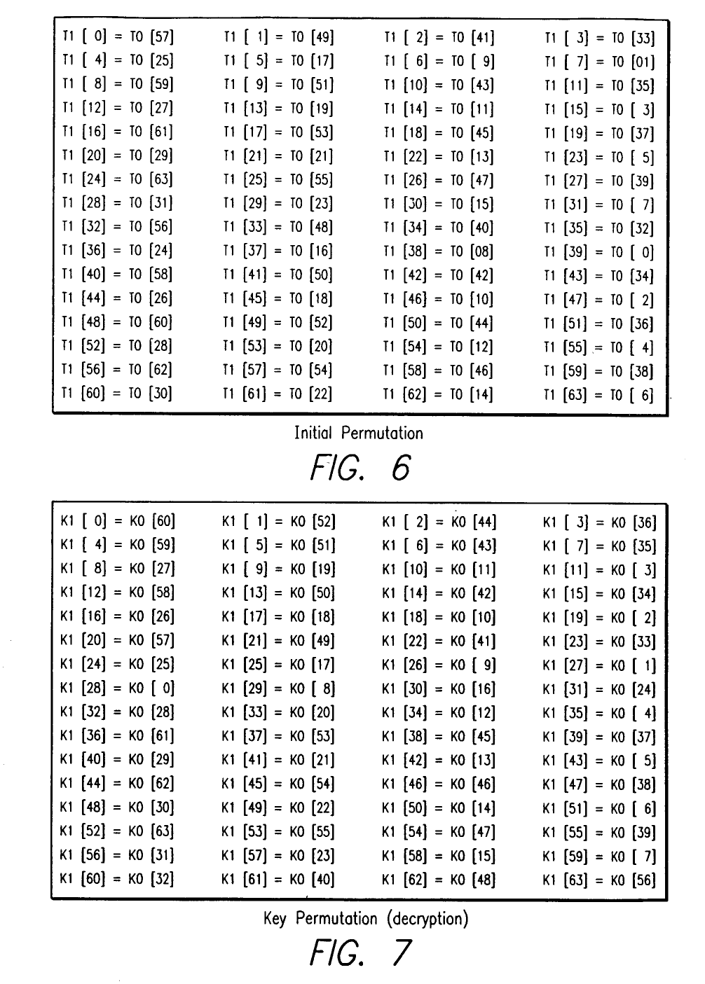

For example, the first step of the DES algorithm is an initial permutation, which is further illustrated by FIG. 6. The initial permutation operates on the first set of text data (i.e., T0[63:0]), to produce a second set of text data (i.e., T1[63:0]). With reference to FIGS. 3, 4-1 and 4-2, the general purpose processor 210 implements the initial permutation function by fetching a permutation instruction, including a permutation opcode 416, a destination identifier rd, an operand identifier rs1, and a permutation identifier rs2. After decoding the permutation opcode 416, the control unit 380 provides a permutation request and the permutation identifier rs2 (i.e., the second operand) to the ALU/encryption unit 320. The permutation identifier rs2 further delineates the type of permutation function that is to be performed. The control unit 380 also provides the operand identifier rs1 to the general purpose registers 340. The general purpose registers 340 then provide the content of the register rs1 (i.e., r[rs1], or the first operand), corresponding to the first set of text data, to the ALU/encryption unit 320. The ALU/encryption unit 320 then performs the initial permutation function (illustrated by FIG. 6) on the first operand to produce a result (i.e., the second set of text data, T1[63:0]). The result is then provided to the general purpose registers 340 along with the destination identifier (i.e., rd). This allows the result to be loaded into register rd of the general purpose registers 340.

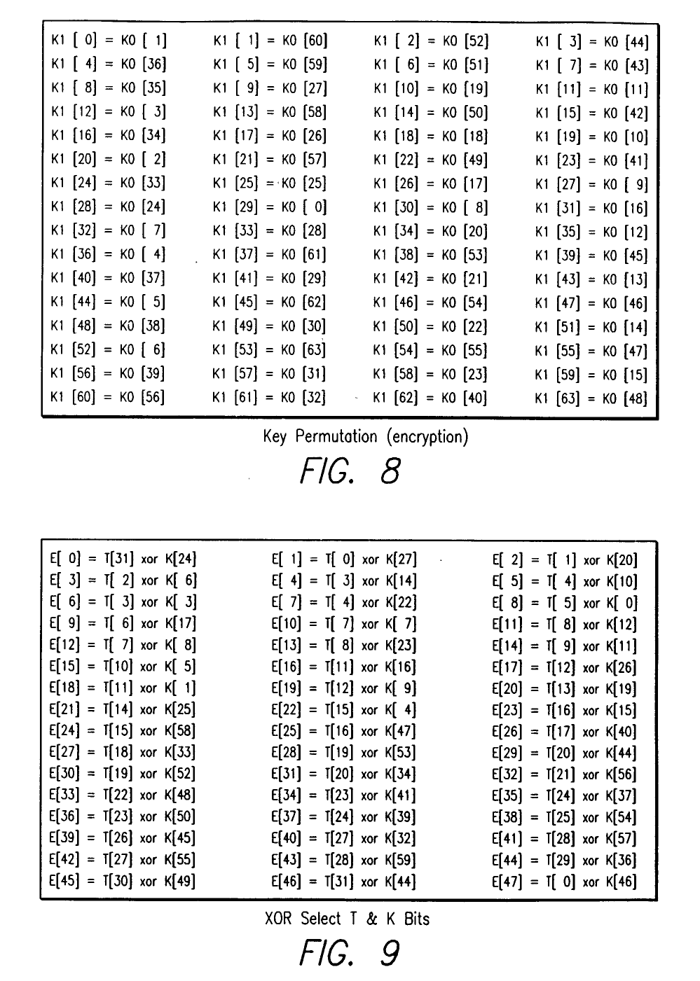

The second step of the DES algorithm is a key permutation, which is further illustrated by FIGS. 7 (decryption) and 8 (encryption). Both of these functions operate on the first set of key data to produce a second set of key data. With reference to FIGS. 3, 4-1 and 4-2, the control unit 380 implements the key permutation function (either for encrypting or decrypting) by fetching and disseminating the permutation instruction as previously discussed. This results in the ALU/encryption unit 320 receiving a permutation instruction, a permutation identifier (e.g., rs2) that delineates the type of permutation to be performed (e.g., key permutation for encryption, key permutation for decryption, etc.), and a first operand (e.g., r[rs1]) corresponding to the first set of key data. The ALU/encryption unit 320 then performs the key permutation function (either for encryption (FIG. 8) or decryption (FIG. 7)) on the first operand to produce a result. The result, which corresponds to the second set of key data (i.e., K1[63:0]), is then loaded into a particular register (e.g., rd) of the general purpose registers 340.

The second set of key data differs from the second set of text data in that only fifty-six bits of the second set of key data are used. Thus, the sixty-four bit second set of key data (i.e., K1[63:0]) includes eight unused bits. In the exemplary DES algorithm described herein, bits K1[27:0] represent the least significant portion of the second set of key data and bits K1[59:32] represent the most significant portion of the second set of key data. It should be appreciated, however, that these bits could be located elsewhere within K1[63:0] with proper adjustment of the indices.

The fourth and eighth step of the DES algorithm is a rotation-by-one permutation and a rotation-by-two permutation, respectively, where the rotation-by-one function operates on the second set of key data to produce a third set of key data, and the rotation-by-two function operates on a fourth set of key data to produce a fifth set of key data. With reference to FIGS. 3, 4-1 and 4-2, the control unit 380 implements the rotation function (either to the left or right) by fetching and disseminating the permutation instruction as previously discussed. This results in the ALU/encryption unit 320 receiving a permutation request, a permutation identifier (e.g., rs2) that delineates the type of permutation to be performed (e.g., rotation by one to the left, rotation by one to the right, rotation by two the left, rotation by two to the right, etc.), and a first operand (e.g., r[rs1]) corresponding to the second or fourth set of key data. The ALU/encryption unit 320 then performs the designated rotation permutation. The result, which corresponds to the third or fifth set of key data, is then loaded into a particular register (e.g., rd) of the general purpose register 340. It should be appreciated, however, that in performing the rotation of the key functions (either by one or by two), each fifty-six bit set of key data is treated as two twenty-eight bit sets, where each set is rotated independent of the other.

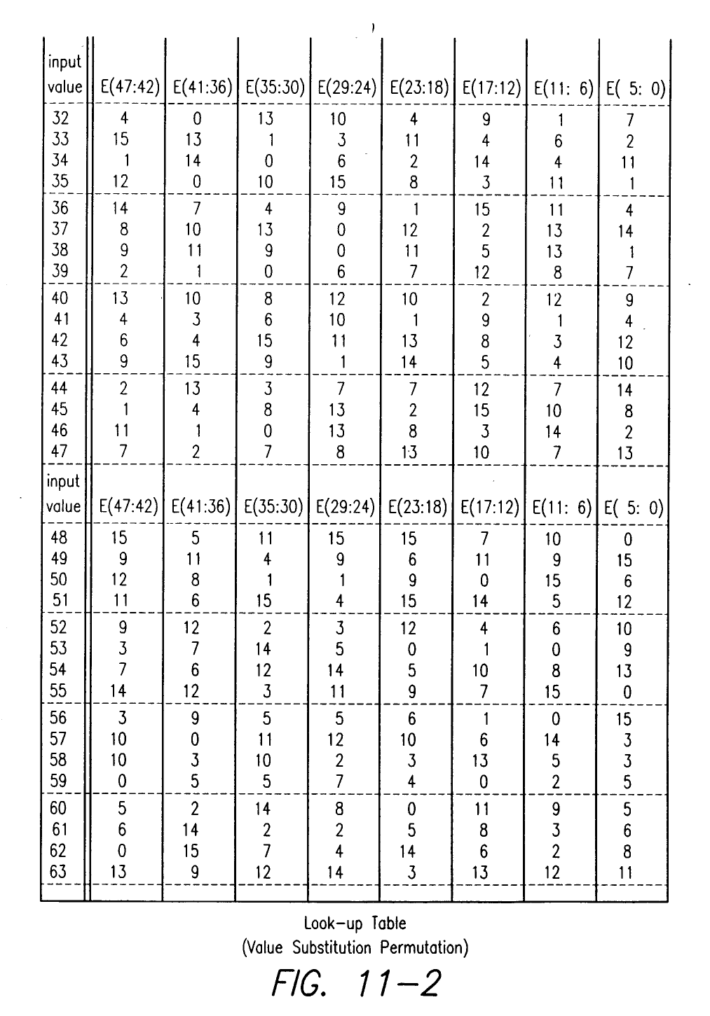

The last step of the DES algorithm is a final permutation, which is further illustrated by FIG. 12. The final permutation function operates on a final set of text data (i.e., T17[63:0]) to produce a resulting set of text data (e.g., ciphertext or plaintext). With reference to FIGS. 3, 4-1 and 4-2, the control unit 380 implements the final permutation function by fetching and disseminating the permutation instruction as previously discussed. This results in the ALU/encryption unit 320 receiving a permutation request, a permutation identifier (e.g., rs2) that delineates the type of permutation to be performed (e.g., the final permutation), and a first operand (e.g., r[rs1]) corresponding to the final set of text data. The ALU/encryption unit 320 then performs the final permutation function (as illustrated by FIG. 12) on the first operand to produce a result. The result, which corresponds to the resulting set of text data (e.g., ciphertext or plaintext), is then loaded into a particular register (e.g., rd) of the general purpose registers 340.

While the steps illustrated in FIG. 5 reflect a single iteration of the DES algorithm, it should be appreciated that performing additional iterations (e.g., performing triple DES) are within the spirit and scope of the present invention. Moreover, if multiple iterations of the DES algorithm are performed (e.g., as with triple DES), a single final/first permutation function may be performed on a final set of text data in lieu of at least the final permutation function of one iteration and the initial permutation function of a next iteration.

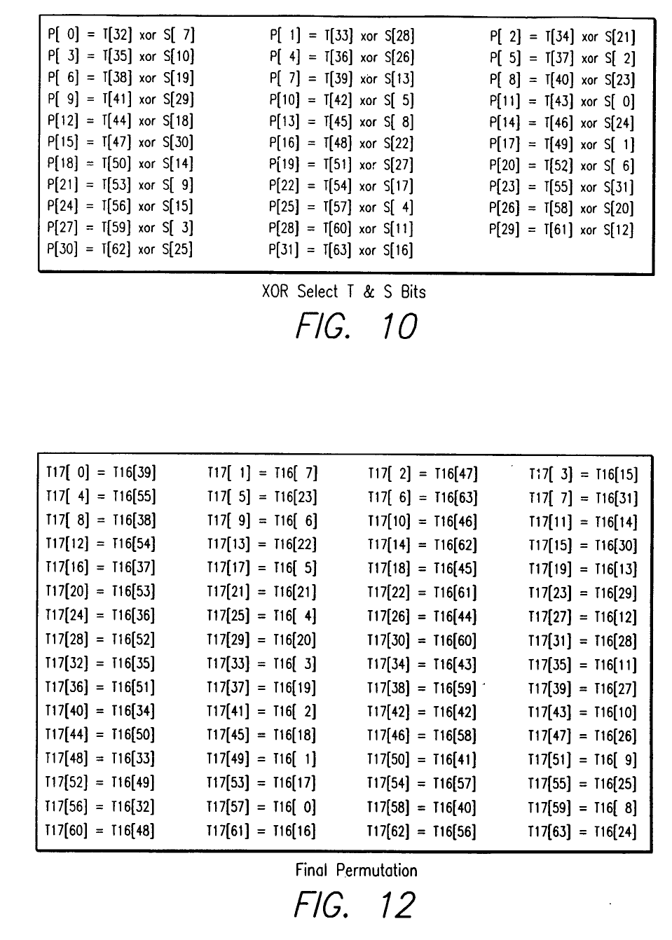

The third step of the DES algorithm is a round computation that operates on the second set of text data and the second set of key data to produce the third set of text data. With reference to FIGS. 3, 4-1 and 4-2, the general purpose processor 210 implements the round computation function by fetching a round instruction, including a round opcode 418, a destination identifier rd, and two operand identifiers rs1, rs2. After decoding the round opcode 418, the control unit 380 provides a round request to the ALU/encryption unit 320 (i.e., instructing the ALU/encryption unit 320 to perform a round function) and two operand identifiers rs1, rs2 to the general purpose registers 340. The general purpose registers 340 then provide the contents of registers rs1 and rs2 (i.e., r[rs1] and r[rs2], or the first and second operands), corresponding to the second set of text data and the second set of key data, to the ALU/encryption unit 320. The ALU/encryption unit 320 then performs a round function on the first and second operands. The round function can be broken down into three sub-functions: (i) a first exclusive-or (XOR) function (i.e., FIG. 9); (ii) a look-up table function (i.e., FIGS. 111 and 11-2); and (iii) a second XOR function (i.e., FIG. 10).

Therefore, in accordance with the three round sub-functions, the ALU/encryption 320 unit performs a first XOR function (i.e., FIG. 9) on the thirty-two least significant bits of the second set of text data (i.e., T1[31:0]) and selected bits from the second set of key data, to produce a forty-eight bit E value. The ALU/encryption 320 unit then performs the look-up table function (i.e., 11-1 and 11-2) on the forty-eight bit E value to produce a thirty-two bit S value.

The look-up table depicted in FIGS. 11-1, 11-2 is actually divided into eight separate look-up tables—one for every six bits of the E value. The correlation between the forty-eight bit input (i.e., E value) and the thirty-two bit result (i.e., S value) is as follows: E[5:0]→S[3:0], E[11:6]→S[7:4], E[17-12]→S[11:8], E[23:18]→S[15-12], E[29:24]→S[19-16], E[35-30]→S[23-20], E[41-36]→S[27-24], E[47-42]→S[31:28]. For example, an E[23:18] value of 52 (i.e., 110100) would result in an S[15:12] value of 12 (i.e., 1100).

The ALU/encryption unit 320 then performs the second XOR function (i.e., FIG. 10) on the thirty-two most significant bits of the second set of text data (i.e., T1[63:32]) and the thirty-two bit S value to produce a thirty-two bit P value. This P value is then used, along with the second set of text data, to produce a third set of text data (i.e., T2[63:32]=T1[31:0] and T2[31:0]=P[31:0]). The third set of text data (i.e, T2[63:0]) is then provided to the general purpose registers 340 along with the destination identifier (i.e., rd). This allows the result to be loaded into register rd of the general purpose registers 340.

To maximize the efficiency of the processing system, the ROM containing the look-up table should have a relatively quick response time. If such a ROM is not available, a quick response time can be achieved by using combinatorial logic to produce the required S value. The use of combinatorial logic to produce read-only data is further described in the co-pending application entitled “System and Method for Small Read Only Data,” filed on Jan. 25, 2002, Ser. No. 10/057,172, which application is specifically incorporated herein by reference.

The remaining round computations (e.g., steps 5, 7, etc.) are performed in the same manner, with the exception of the last round computation of the DES algorithm (i.e., step 33). The result of the last round computation (i.e., the final set of text data) should be assembled in reverse order before the final permutation function is performed (i.e., T17[63:32]=P[31:0] and T17[31:0]=T16[31:0]). Thus, either an alternate round opcode could be implemented to produce a reverse order result, or the permutation opcode could be adapted to implement a reverse order permutation, either as a standalone permutation or together with the final permutation.

It should be appreciated that the round and permutation opcodes/functions described herein not only allow the ALU/encryption unit of the general purpose processor to implement the DES algorithm, but the DES algorithm is broken down in such a manner that the data being operated on is, at most, sixty-four bits in length. This is significant because most general purpose registers are sixty-four bit registers. Thus, the present invention not only enables a general purpose processor to implement at least a portion of the DES algorithm by using an encryption unit adapted to implement round and/or permutation opcodes, but it does so using its general purpose control structure and its general purpose registers.

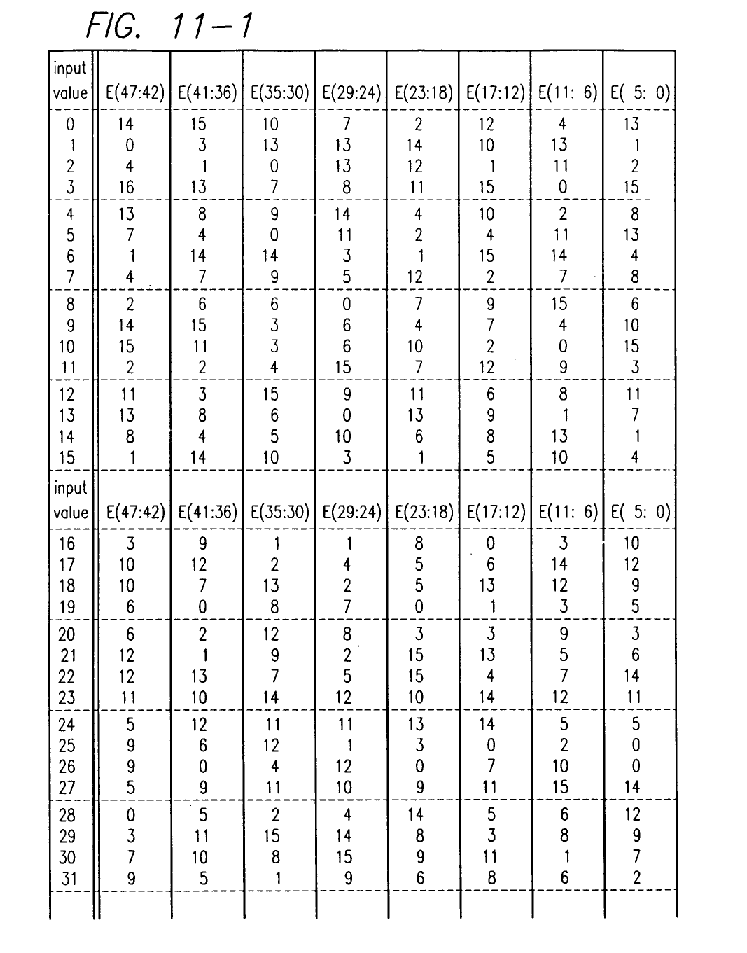

In another embodiment of the present invention, it is possible to implement the entire DES algorithm without using a round opcode. In this embodiment, the round computations illustrated in FIG. 5 are implemented using four additional permutations (i.e., FIGS. 11 and 13-15) and two XOR functions. For example, step three of the DES algorithm (i.e., FIG. 5) depicts that a round computation is to be performed on a second set of key data and a second set of text data to obtain a third set of text data.

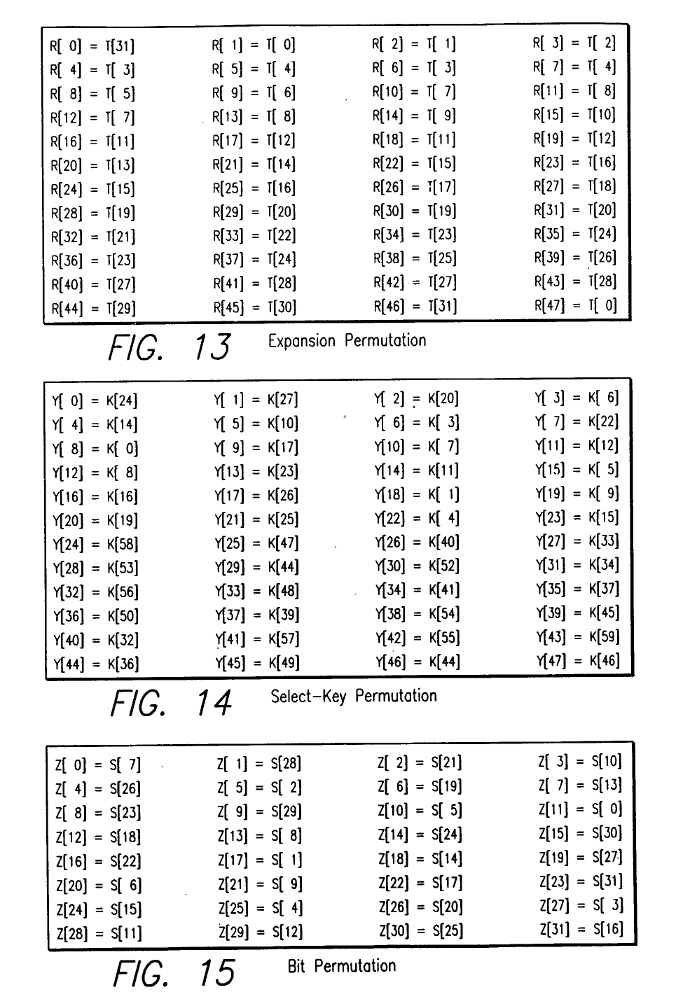

This can be accomplished by implementing an expansion permutation function (i.e., FIG. 13) on selected bits from the second set of text data to produce a forty-eight bit R value, and a select-key permutation function (i.e., FIG. 14) on selected bits from the second set of key data to produce a forty-eight bit Y value. A first XOR function is then performed on the forty-eight bit R value and the forty-eight bit Y value, resulting in a forty-eight bit E value. The value substitution permutation (i.e., FIGS. 11-1, 11-2), or the look-up table function, is used to determine a thirty-two bit S value as described above. The bit permutation (i.e., FIG. 15) is then used to produce a thirty-two bit Z value from the thirty-two bit S value. It should be appreciated that the thirty-two bit Z value is the same as the thirty-two bit S value discussed in conjunction with the round function.

Therefore, a second XOR function (i.e., FIG. 10, where S[31:0]=Z[31:0]), is then performed on the thirty-two bit Z value and the thirty-two most significant bits of the second set of text data (i.e., T1[63:32]) to produce a thirty-two bit P value. This P value is then used, along with the second set of text data to produce a third set of text data (i.e., T2[63:32]=T1[31:0]and T2[31:0]=P[31:0]). It should be appreciated, however, that this method of implementing the round functions does not affect the fact that the final set of text data needs to be reversed before the final permutation function is performed, as discussed above.

Having thus described a preferred embodiment of a system and method for using a general purpose processor containing permutation and/or round opcodes for encrypting and/or decrypting data in accordance with the DES algorithm, it should be apparent to those skilled in the art that certain advantages of the system have been achieved. It should also be appreciated that various modifications, adaptations, and alternative embodiments thereof may be made within the scope and spirit of the present invention. For example, even though an encryption unit adapted to implement both round and permutation functions has been described herein, it should be appreciated that an encryption unit adapted to implement the permutation function alone is within the spirit and scope of the present invention. The invention is further defined by the following claims.

What is claimed is:

1. A method of implementing at least a portion of the data encryption standard (DES) algorithm on a general purpose processor comprising:
fetching a permutation instruction comprising a permutation opcode and a permutation identifier;
decoding said permutation opcode to determine the function that is to be performed;
instructing an encryption unit to perform a DES permutation function by sending a permutation request and said permutation identifier to said encryption unit;
performing a DES permutation function in response to receiving said permutation request and said permutation identifier, said permutation identifier delineating the type of DES permutation function that is to be performed; and
loading the permutation result of said DES permutation function in a general purpose register.

2. The method of claim 1, wherein said step of loading said permutation result in said general purpose register further includes loading said permutation result in a particular general purpose register identified by a destination identifier, said permutation instruction further including said destination identifier.

3. The method of claim 1, wherein said step of performing said DES permutation function further includes performing said DES permutation function on the content of a particular general purpose register identified by an operand identifier, said permutation instruction further including said operand identifier.

4. The method of claim 1, further comprising:
fetching a round instruction comprising a round opcode;
decoding said round opcode to determine the function that is to be performed;
instructing said encryption unit to perform a DES round function by sending a round request to said encryption unit;
performing a DES round function in response to receiving said round request; and
loading the round result of said DES permutation function in a general purpose register.

5. The method of claim 4, wherein said step of loading said round result in said general purpose register further includes loading said round result in a particular general purpose register identified by a destination identifier, said round instruction further including said destination identifier.

6. The method of claim 4, wherein said step of performing said DES round function further includes performing said DES round function on the contents of two particular general purpose registers corresponding to two operand identifiers, said round instruction further including said two operand identifiers.

7. The method of claim 1, wherein said step of performing said DES permutation function further includes performing an initial-permutation function on a first set of text data to produce a second set of text data.

8. The method of claim 1, wherein said step of performing said DES permutation function further includes performing a key-permutation function on a first set of key data to produce a second set of key data.

9. The method of claim 1, wherein said step of performing said DES permutation function further includes performing a circular-rotation-of-the-key-by-one function on a second set of key data to produce a third set of key data.

10. The method of claim 1, wherein said step of performing said DES permutation function further includes performing a circular-rotation-of-the-key-by-two function on a fourth set of key data to produce a fifth set of key data.

11. The method of claim 1, wherein said step of performing said DES permutation function further includes performing a final-permutation function on a final set of text data to produce a resulting set of text data.

12. The method of claim 4, wherein said step of performing said DES round function further includes performing:
a first-exclusive-or function on a least-significant-bit portion of a second set of text data and a portion of a second set of key data to produce a first set of E data;
a look-up-table function on said first set of E data to produce a first set of S data; and
a second-exclusive-or function on a most-significant-bit portion of said second set of text data and said first set of S data to produce a first set of P data, said first set of P data being the least significant bits in a third set of text data.

13. The method of claim 9, wherein said step of performing a circular-rotation-of-the-key-by-one function further includes performing a circular-rotation-of-the-key-by-one function to the left if a first set of text data is being encrypted and to the right if said first set of text data is being decrypted.

14. The method of claim 10, wherein said step of performing a circular-rotation-of-the-key-by-two function further includes performing a circular-rotation-of-the-key-by-two function to the left if a first set of text data is being encrypted and to the right if said first set of text data is being decrypted.

15. The method of claim 1, wherein said step of performing said DES permutation function further includes performing an expansion-permutation function on a least-significant-bit portion of a second set of text data to produce a first set of R data.

16. The method of claim 1, wherein said step of performing said DES permutation function further includes performing a select-key-permutation function on a portion of a second set of key data to produce a first set of Y data.

17. The method of claim 1, wherein said step of performing said DES permutation function further includes performing a value-substitution-permutation function on a first set of E data to produce a first set of S data.

18. The method of claim 1, wherein said step of performing said DES permutation function further includes performing a bit-permutation function on said first set of S data to produce a first set of Z data.

19. The method of claim 11, wherein said step of performing said final-permutation function further includes performing a reverse-order permutation function immediately proceeding said final-permutation function.

20. The method of claim 4, further comprising:
fetching an alternate-round instruction comprising an alternate-round opcode;
decoding said alternate-round opcode to determine the function that is to be performed;
instructing said encryption unit to perform a DES alternate-round function by sending an alternate-round request to said encryption unit; and
performing a DES alternate-round function in response to receiving said alternate-round request, said alternate-round function comprising:
performing a first-exclusive-or function on a least-significant-bit portion of a seventeenth set of text data and a portion of a seventeenth set of key data to produce a sixteenth set of E data;
performing a look-up-table function on said sixteenth set of E data to produce a sixteenth set of S data; and
performing a second-exclusive-or function on a most-significant bit portion of said seventeenth set of text data and said sixteenth set of S data to produce a sixteenth set of P data, said sixteenth set of P data being the most significant bits in a final set of text data.

21. A method of implementing at least a portion of the data encryption standard (DES) algorithm on a general purpose processor, said general purpose processor being adapted to perform a portion of said DES algorithm in response to receiving a permutation opcode, comprising:
obtaining a first set of text data and a first set of key data from a plurality of sixty-four bit general purpose registers;
performing an initial-data-permutation function on said first set of text data to produce a second set of text data;
performing a key-permutation function on said first set of key data to produce a second set of key data;
performing a round computation on said second set of text data and said second set of key data to produce a third set of text data;
performing a rotation computation by performing a circular-rotation-of-the-key function on said second set of key data to produce a third set of key data;
repeating said round and rotation computation to produce a final set of text data; and
performing a final-data-permutation function on said final set of text data to produce a resulting set of text data.

22. The method of claim 21, wherein said round computation comprises:
obtaining said second set of text data and said second set of key data from said plurality of sixty-four bit general purpose registers; and
performing a first-exclusive-or function on a least-significant-bit portion of said second set of text data and a portion of said second set of key data to produce a first set of E data;
performing a look-up-table function on said first set of E data to produce a first set of S data; and
performing a second-exclusive-or function on a most-significant-bit portion of said second set of text data and said first set of S data to produce a first set of P data, wherein said first set of P data and said least-significant-bit portion of said second set of text data is used to produce a third set of text data.

23. The method of claim 21, wherein said round computation comprises:
performing an expansion-permutation function on a least-significant-bit portion of said second set of text data to produce a first set of R data;
performing a select-key-permutation function on a portion of said second set of key data to produce a first set of Y data;
performing an exclusive-or (XOR) on said first set of R data and said first set of Y data to produce a first set of E data;
performing a value-substitution-permutation function on said first set of E data to produce a first set of S data;
performing a bit-permutation function on said first set of S data to produce a first set of Z data; and
performing an XOR on said first set of Z data with a most-significant-bit portion of said second set of text data to produce a first set of P data, wherein said first set of P data and said least-significant-bit portion of said second set of text data is used to produce a third set of text data.

24. The method of claim 21, further comprising performing a reverse-order permutation computation immediately proceeding said final-permutation function.

25. The method of claim 21, further comprising:
performing said first-exclusive-or function on a least-significant-bit portion of a seventeenth set of text data and a portion of a seventeenth set of key data to produce a sixteenth set of E data;
performing said look-up-table function on said sixteenth set of E data to produce a sixteenth set of S data; and
performing said second-exclusive-or-function on a most-significant-bit portion of said seventeenth set of text data and said sixteenth set of S data to produce a sixteenth set of P data, said sixteenth set of P data being the most significant bits in a final set of text data.

26. A general purpose processor for encrypting and decrypting data using the data encryption standard (DES) algorithm, said general purpose processor comprising:
a memory adapted to store a permutation instruction comprising a permutation opcode and a permutation identifier;
a control unit adapted to generate a permutation request in response to receiving said permutation opcode from said memory;
a plurality of general purpose registers; and
an encryption unit adapted to perform a DES permutation function on an operand obtained from said plurality of general purpose registers in response to receiving said permutation request and said permutation identifier, said permutation identifier delineating the type of DES permutation function that is to be performed.

27. The general purpose processor of claim 26, wherein said memory is further adapted to store a round instruction comprising a round opcode, said control unit is further adapted to generate a round request in response to receiving said round opcode from said memory, and said encryption unit is further adapted to perform a DES round function on two other operands obtained from said plurality of general purpose registers in response to receiving said round request.

28. The general purpose processor of claim 26, wherein said plurality of general purpose registers consist of a plurality of sixty-four bit general purpose registers.

29. The general purpose processor of claim 26, wherein said permutation instruction further comprises a destination identifier and an operand identifier, said operand identifier corresponding to a particular one of said plurality of general purpose registers containing said operand.

30. The general purpose processor of claim 26, further comprising an I/O interface operatively connected to at least one communication device, said at least one communication device selected from a list consisting of a local communication device and a remotely located communication device.
